(19) United States
(12) Patent Application Publication
(10) Pub. No.: US 2024/0355492 A1
(43) Pub. Date: Oct. 24, 2024

(54) High-Resolution Scanning Camera System

(71) Applicant: Vega Wave Systems, Inc., WEST CHICAGO, IL (US)

(72) Inventors: Alan Sugg, NAPERVILLE, IL (US); Anthony Moretti, Saint Charles, IL (US)

(73) Assignee: Vega Wave Systems, Inc., WEST CHICAGO, IL (US)

(21) Appl. No.: 18/684,399

(22) PCT Filed: Aug. 15, 2022
(86) PCT No.: PCT/US22/40293

§ 371 Date: Feb. 16, 2024

Related U.S. Application Data
(60) Provisional application No. 63/233,709, filed on Aug. 16, 2021.

(51) Int. Cl. G21C 17/08; G02B 13/00; G02B 23/24; G02B 26/10

(52) U.S. Cl. CPC G21C 17/08; G02B 13/0005; G02B 23/2492; G02B 26/101

(57) ABSTRACT

Articles of manufacture, machines, processes for using the articles and machines, processes for making the articles and machines, and products produced by the process of making, along with necessary intermediates, directed to a scanning camera system.

### I. BACKGROUND

Currently, visual inspection systems for nuclear energy applications, e.g., in a reactor vessel or in accident conditions, are quite limited. Commercially available radiation-hardened vision systems are rated to 1 MGy, limiting their use to radiation levels lower than in areas where it is needed for accurate, reliable inspections. To achieve this radiation hardness, even after replacing the radiation-sensitive image sensors with 1980's-vintage vidicon tubes, these systems rely on encasing the units with heavy lead shielding, resulting in weights of ˜80 lbs., rendering them difficult to use. In the case of nuclear accidents, lighter, smaller, and more maneuverable systems are needed. The current systems based on vidicon tubes have resolution of 550-600 horizontal lines. In the case of the Fukushima accident an industrial video system was used that was rated to radiation doses up to 1000 Gy, but this video system lasted 14 hours at a radiation level of 70 Gy/hr. Clearly, better and more radiation-hardened vison systems are needed. Further, a high-definition system would be much more useful in the inspection process.

Accordingly, there is a need for improvement over such past approaches and for alternatives such as those that are more convenient to use.

### II. SUMMARY

The disclosure below uses different embodiments to teach the broader principles with respect to articles of manufacture, apparatuses, processes for using the articles and apparatuses, processes for making the articles and apparatuses, and products produced by the process of making, along with necessary intermediates, directed to direct nuclear power conversion. This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

The following description and drawings are illustrative and are not to be construed as limiting. Numerous specific details are described to provide a thorough understanding of the disclosure. However, in certain instances, well-known or conventional details are not described in order to avoid obscuring the description.

References to one or an embodiment in the present disclosure can be, but not necessarily are, references to the same embodiment; and such references mean at least one of the embodiments. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure and in the specific context where each term is used.

Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind and similarly applicable, consider U.S. Patent Application No.: 63/181,139, filed on Apr. 28, 2021, and incorporated by reference as if fully restated herein; consider an apparatus (method of using, method of making, and products produced thereby) including scanning camera system such as a system including a camera specially adapted to survive, and show minimal degradation in the presence of, high levels of radiation such as is encountered in nuclear power plant refueling, inspection and monitoring, nuclear fuel production, inspection and storage, nuclear spent fuel inspection, repair and storage, nuclear accident conditions, radiation hot cells, or similar applications where there is gamma, x-ray, neutron or other high-energy particle or high-energy photon radiation. Some implementations lower radiation-induced noise.

### III. INDUSTRIAL APPLICABILITY

Industrial applicability is representatively directed to that of apparatuses and devices, articles of manufacture-particularly scanning camera systems-and processes of making and using them. Industrial applicability also includes industries engaged in the foregoing, as well as industries operating in cooperation therewith, depending on the implementation.

### IV. DRAWINGS

In the non-limiting examples of the present disclosure, please consider the following:

FIG. 1 is a block diagram of a scanning video system.

FIG. 2 is a block diagram of a scanning video system.

FIG. 3A is an external mechanical drawing of a scanning head assembly with adjustable focus optics for the scanned laser beam.

FIG. 3B is an external mechanical drawing of a scanning head assembly with adjustable focus optics for the scanned laser beam.

FIG. 3C is an external mechanical drawing of a scanning head assembly with adjustable focus optics for the scanned laser beam.

FIG. 3D is an external mechanical drawing of a scanning head assembly with adjustable focus optics for the scanned laser beam.

FIG. 4A is an internal mechanical drawing of a scanning head assembly with adjustable focus optics for the scanned laser beam.

FIG. 4B is an internal mechanical drawing of a scanning head assembly with adjustable focus optics for the scanned laser beam.

FIG. 4C is an internal mechanical drawing of a scanning head assembly with adjustable focus optics for the scanned laser beam.

FIG. 4D is an internal mechanical drawing of a scanning head assembly with adjustable focus optics for the scanned laser beam.

FIG. 5 is an internal mechanical drawing of a scanning head assembly with

adjustable focus optics for the scanned laser beam using a fiber detection bundle and two single-axis MEMS for the scanning assembly.

FIG. 6 is a mechanical isolation view of the fiber laser output with collimation optics for the illumination optical fiber source, and the path of the laser scan beam through the dual MEMS scanning system and output focus lens system.

FIG. 7 is an alternate view of a mechanical isolation view of the fiber laser output with collimation optics for the illumination optical fiber source, and the path of the laser scan beam through the dual MEMS scanning system and output focus lens system.

FIG. 8A is a mechanical view of a fixed focus camera head using an f-theta lens assembly.

FIG. 8B is a mechanical view of a fixed focus camera head using an f-theta lens assembly.

FIG. 8C is a mechanical view of a fixed focus camera head using an f-theta lens assembly.

FIG. 8D is a mechanical view of a fixed focus camera head using an f-theta lens assembly.

FIG. 9A is a mechanical view of the internal parts of a fixed focus camera head using an f-theta lens assembly.

FIG. 9B is a mechanical view of the internal parts of a fixed focus camera head using an f-theta lens assembly.

FIG. 9C is a mechanical view of the internal parts of a fixed focus camera head using an f-theta lens assembly.

FIG. 9D is a mechanical view of the internal parts of a fixed focus camera head using an f-theta lens assembly.

FIG. 10 is a mechanical cross-section view of internal parts of a fixed focus camera head using an f-theta lens assembly a fiber bundle and MEMS-based scan system with a scanning beam.

FIG. 11 is a mechanical isolation view of the scanning assembly using a collimated optical fiber output for the illumination optical fiber source, and the path of the laser scan beam through the dual MEMS scanning system.

FIG. 12 is a mechanical isolation view of the scanning assembly using a collimated optical fiber output for the illumination optical fiber source, and the path of the laser scan beam through the dual MEMS scanning system and including the f-theta output lens.

FIG. 13 is an alternate view of the mechanical isolation view of the scanning assembly using a collimated optical fiber output for the illumination optical fiber source, and the path of the laser scan beam through the dual MEMS scanning system and including the f-theta output lens.

FIG. 14 is a diagram of an embodiment of a homodyne transceiver.

FIG. 15 is a diagram of a homodyne demodulator with the input frequency spectrum showing the local oscillator frequency and the lower and upper sidebands.

### V. DETAILED DISCLOSURE OF MODES

Consider generally a camera system comprised of a camera head containing a scanning element. The scanning element is in communication with a separate, electronics element that controls the scanning element and that detects and reconstructs one or more images from a scanned scene. In some, but not all, cases, there is no active light source and/or no active detector that are part of the camera head. (An active light source is a light source requiring one or more electrical connections. An active light detector is a detector that can be comprised of a detecting element requiring one or more electrical connections.)

Similarly, in some, but not all, cases, the camera head contains no elements comprised of field-effect transistors or p-n junctions. Rather, the camera head conveys the scanned image (field of view or scene) to the separate electronics element, e.g., an active detector located outside of the camera head; the image(s) is/are reconstructed by electronics connected to the active detector and/or by software to assemble a representative image of the scanned image(s). There can be a reconstruction of the scanned scene, such as a product, and the reconstruction can be printed if so desired, another manner of viewing a product. And of course, an apparatus can be a product of the process of making the apparatus.

Also consider the following as a prophetic teaching of general, potential concepts rather than as limitations. So for illustrative, nonlimiting purposes, consider that the elements of the active scan camera system can include control electronics located remotely from the camera head and containing an active detector and electronics structured to control the scanning element and hardware and/or hardware and software structured to reconstruct the signal(s) from the active detector of the scanned scene into a video signal and convey the video signal to, for example, frame-grabber electronics and software for scene reconstruction. In some, but not all, cases the active detector can comprise a fiber-coupled photomultiplier tube detector (PMT), a fiber-coupled avalanche photodiode detector (APD), a fiber-coupled photodiode, etc.

The camera head in some cases contains a scanning mirror, such as a microelectromechanical system (MEMS) scanning mirror system using two, one-dimensional scan axis MEMS, a single two-dimensional scan axis MEMS, etc. The camera head may contain a scanner such as an electrostatic MEMS, a magnetic MEMS, a thermal MEMS, etc., and in some cases, the scanner includes a rotating mirror assembly.

The camera head can contain a separate optical fiber that delivers a light source for scanning the scene and a separate optical detector fiber that conveys the backscattered light from the scene to the active detector located outside the camera head, though in some implementations, one fiber can convey the scanning and backscattered light paths. Illustratively, a photonic crystal fiber optical fiber can be used to convey the light to the active detector, or a multi-mode optical fiber can be used to convey the light to the active detector. In this manner, an optical fiber is used to provide light as if it were a light source located in the camera head, so as to illuminate the scene. In such an implementation, the end of the optical fiber located in the camera head extends to a laser diode that is not located in the camera head. In some, but not all, cases, the laser diode is a continuous wave laser diode source. Illustratively, the wavelength of the laser diode can be approximately 405 nm, and in some cases, in the range of 100 nm to 5 μm. At an end of the optical fiber conveying the backscattered light path, there can be an optical filter at the active detector for reduced collection of ambient light at the active detector.

In some cases, a high-resolution system scanning camera systems can be used described above that has a capability of providing high-definition video, but in any case, the scanning system can be carried out with one or more of, or in a combination of one or more of, the following added or substituted elements: Add an optical element (a lens or lens assembly) to focus the scanned laser to small spot, e.g., where the optical element is an F-theta lens, a lens assembly with one or more elements that allows either a fixed focus or an adjustable focus for range of focal lengths, and/or one or more reflective optic elements, and/or one or more diffractive optic elements.

In some, but not all cases, the detector fiber can be comprised of a bundle of fibers, or comprised of an array of fibers, and there may, but need not, equip the detector fiber with a lens element to direct light into the fiber. If so desired, multiple parallel scan systems can be used for greater field of view that is, for example, time multiplexed or wavelength multiplexed, e.g., using a filtered detector. Note that some, not all, embodiments can use a rotated or swiveled scan system to increase the field of view of the scanned scene.

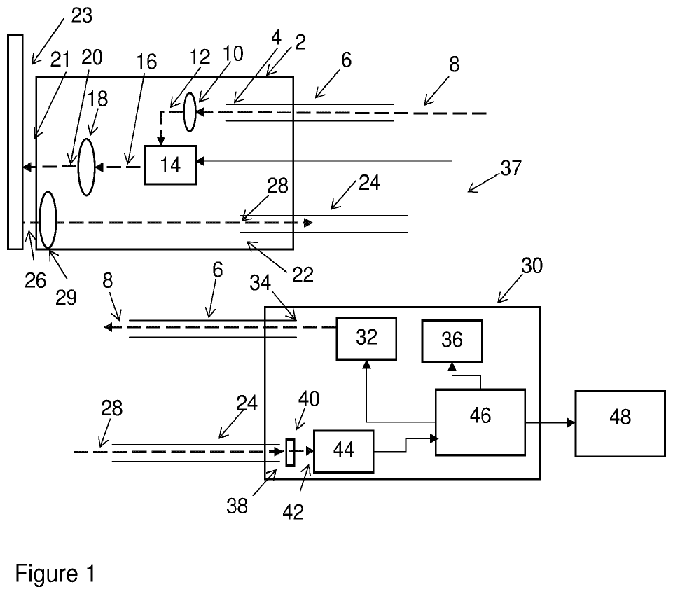

More particularly, turn now to the figures for further illustration, commencing with FIG. 1, which provides a block diagram of a (e.g., real time) fiber-based scanning video system such as for high radiation environments e.g., above background radiation, in a nuclear reactor, lethal radiation areas, etc., depending on the implementation. As a non-limiting teaching, there can be a camera head 2 comprising a first end 4 of a first light path 6 located to emit delivered light 8, a first focusing optic element 10 (e.g., a collimating optic element) located to focus the delivered light 8 as focused light 12, a scanning mirror system 14 located to orient the focused light 12 as oriented light 16, a second focusing optic element 18 located to focus the oriented light 16 as focused oriented light 20, and a first end 22 of a backscattered light path 24 located to collect backscattered light 26 from the focused oriented light 20 as collected light 28. In operable connection therewith, the teaching includes control electronics 30 comprising: an active light source 32 connected so as to provide the deliver light 8 to a second end 34 of the first light path 6, a control 36 governs the scanning mirror system 14, a second end 38 of the backscattered light path 24 located to emit the collected light 28 as received light 42, an active light detector 44 located to detect the received light 42 as detected light (not shown), electronics 46 (or electronics and software) configured to construct an image (not sown) from the detected light, and display electronics 48 configured to display the image (not shown). Cable 37 allows the control 36 to communicatively govern scanning mirror system 14. In some, but not all, embodiments the apparatus can include a filter 40 intermediate the second end 38 of the backscattered light path 24 and the active light detector 44 and can, but need not always, further include a third optic element 29, adjacent the first end 22 of the backscattered light path 24, positioned to direct the backscattered light 26 toward the backscattered light path 24. In one of the possible methods of using the apparatus, an object 23 in a high radiation environment or area 21 can be scanned by the apparatus to produce an image (not shown) in output such as a display shown by display electronics 48. In use, the camera head 2 is located in the higher radiation area or environment and the control electronics 30 is located in a lower radiation environment or area.

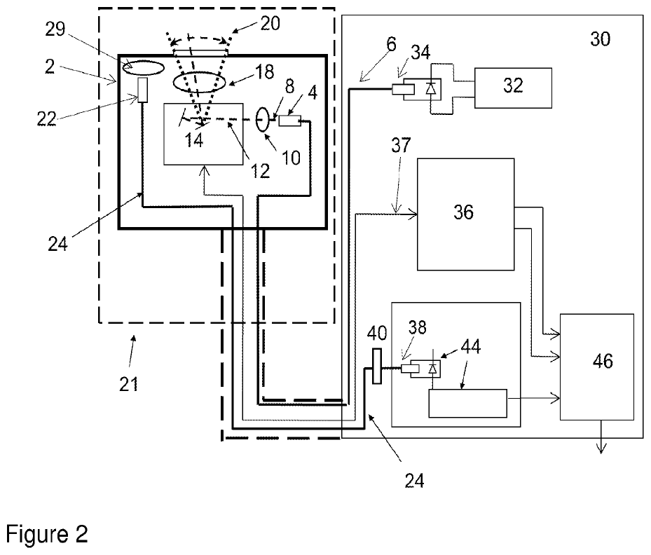

FIG. 2 furthers a non-limiting teaching, illustrating by its block diagram, that there can be an embodiment in which a real time scanning video system is fiber-based, i.e., uses one or more (e.g., a bundle) radiation-tolerant optical illumination optic fibers to provide the first light path 6 and one or more (e.g., a bundle) radiation-tolerant optical fibers to provide the backscattered light path 24. Thus, the notion of a light collection fiber (first end 22, backscattered light path 24, and second end 38) can in some cases be carried out with a fiber bundle (each fiber having a first end 22, a backscattered light path 24, and a second end 38). If so desired in one application or another, a filter 40 can be located to filter and/or focus backscattered light 26 toward the first end 22 of the backscattered light path 24. If so desired in one application or another, an optic 29 can be located to focus and/or filter backscattered light 26 toward the first end 22 of the backscattered light path 24. Note that this is a teaching example, and so, for example, the first light path 6 may be comprised of a first light guide, a one light guide connected to a second light guide, etc. A light guide can be an optic fiber or bundle of fibers, a light tube, etc.

The camera head 2 can contain a two element one-dimensional MEMS mirror system 14, or a single 2-dimensional MEMS mirror 14 as may be preferred for one application or another. The delivered light 8 emitted at the first end 4 of the first light path 6 and is focused using the first optic element 10, e.g., a collimating optic, to produce focused light 12. Focused light 12 also is thereby directed onto the scanning mirror system 14, e.g., a MEMS mirror system, to scan a scene, e.g., object 23 in a higher radiation environment or area 21 (i.e., higher radiation environment or area 21 than the location in use of the control electronics 30). An electrical drive signal cable 37, e.g., contained within a flexible conduit, communicatively connects control 36 and the scanning mirror system 14. The control electronics 30 contains the MEMS drive electronics of, for example, control 36 and optical detection system, i.e., the active detector 44, and image or video processor electronics 46. The control electronics 30 can be connected to a digital computer, e.g., a PC or other hardware, or in some embodiments video frame grabber software, control software, and user interface. The control electronics 30 also can contain the active light source 32, e.g., a laser driver and fiber-coupled laser. Filter 40 can be one or more optical filter or filters to adjust the collected light 28 before it enters the active light detector 44.

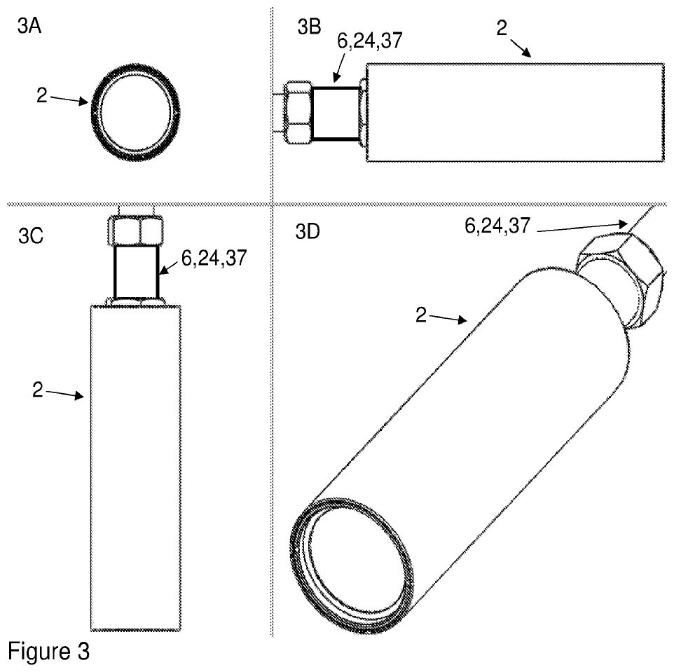

FIGS. 3A, 3B, 3C, and 3D are illustrative, external, mechanical drawings of a scanning camera head 2 assembly with the first light path 6, the backscattered light path 24, and cable 37.

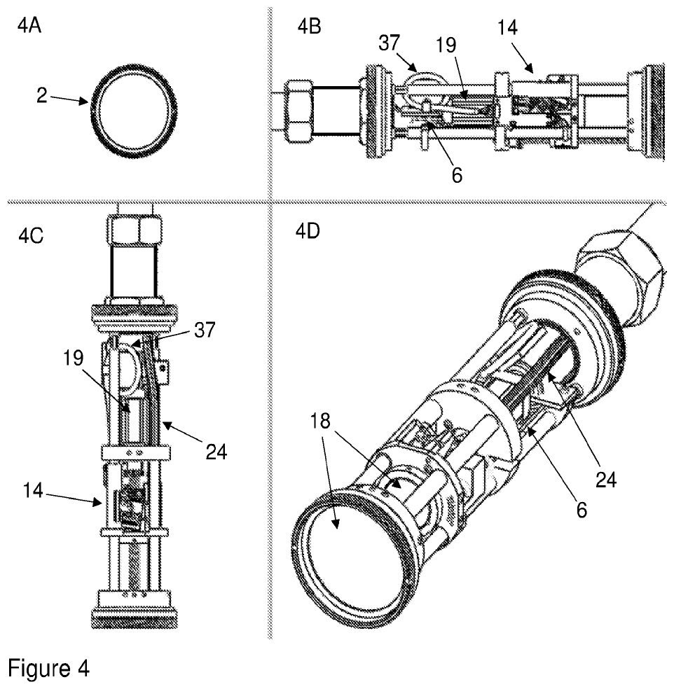

FIGS. 4A, 4B, 4C, and 4D are illustrative, internal, mechanical drawings of a scanning camera head 2 assembly with the first light path 6, the backscattered light path 24, and the cable 37.

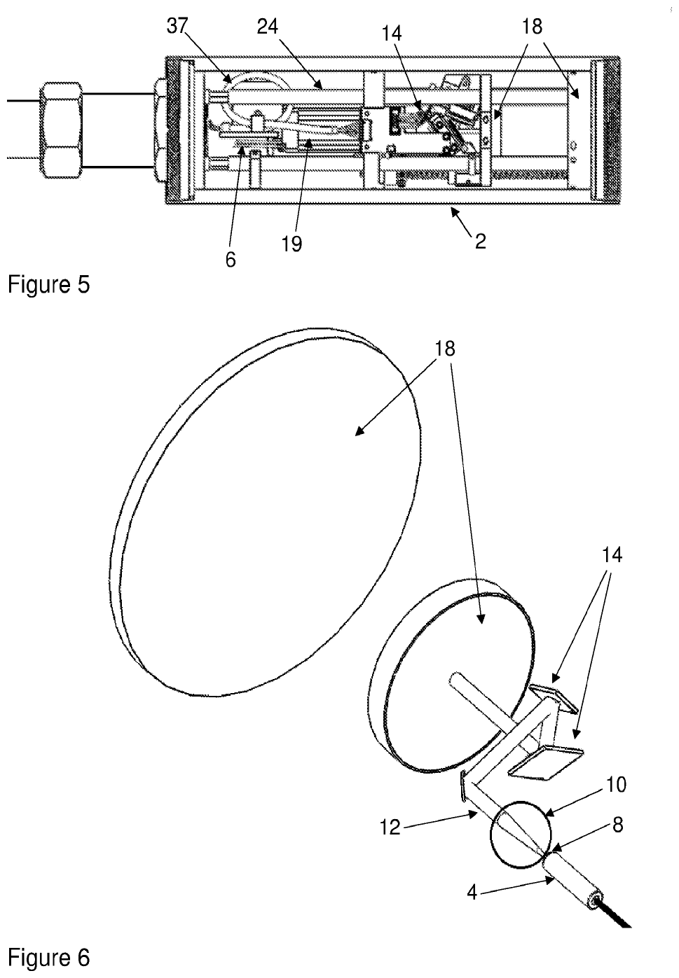

FIG. 5 yet furthers a non-limiting teaching, illustrating by way of an internal mechanical drawing of a scanning camera head 2 assembly with adjustable focus optics of scanning mirror system 14. A first component (e.g., a lens, more than one lens, a diffractive optical element, a reflective optical element, etc.) of the second focusing optic element 18 can be mounted on a fixture moved by motor 19 relative to a second element of the second focusing optic element 18 so as to change the focus of the second focusing optic element 18. The backscattered light 26 is collected by the fiber bundle embodiment of light path 24.

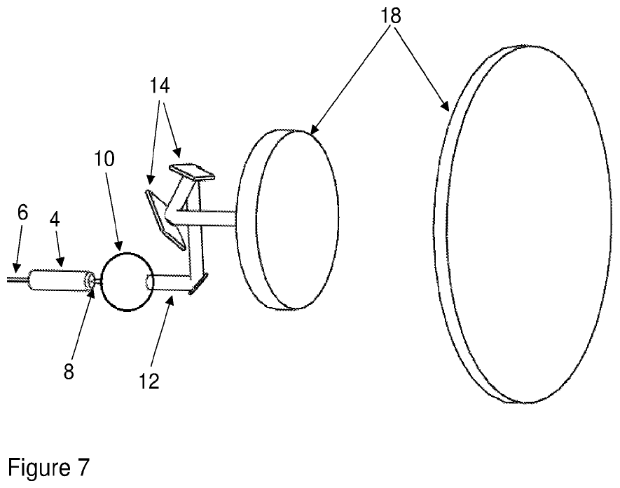

FIG. 6 also furthers a non-limiting teaching, illustrating a mechanical isolation view of the first end 4, first optic element 10, such as collimation optics, and delivered light 8, such as fiber-coupled laser output. The scanning mirror system 14, e.g., a dual MEMS scanning system, is located receives the focused light 12 and conveys the focused oriented light 12 to second focusing optic elements(s) 18.

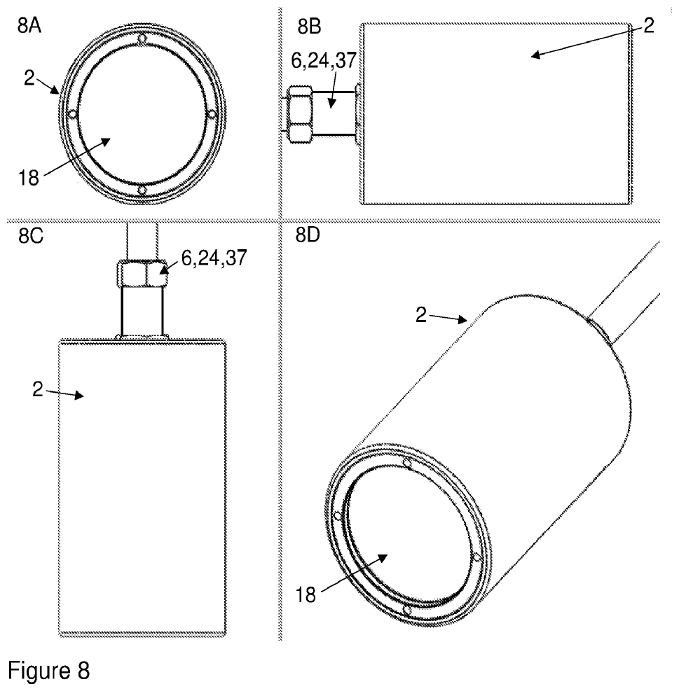

In another embodiment, illustrated in the FIG. 7 mechanical isolation view of the first light path 6, e.g., a fiber-coupled laser, showing the delivered light 8 after the first optic element 10, e.g., collimation optics for the focused light 12 conveyed through the scanning mirror system 14, e.g., the dual MEMS, and leading to the output to the second focusing optic element 18, e.g., a lens system.

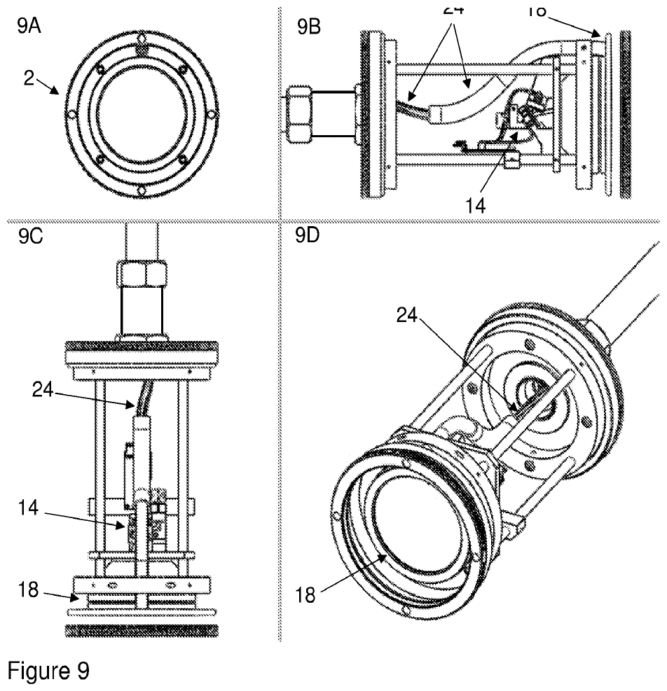

FIGS. 8A, 8B, 8C, and 8D are illustrative, external, mechanical views of a fixed focus camera head using an f-theta lens assembly. With respect as to a fixed-focus camera head 2 using an f-theta lens assembly as second focusing optic element 18, there can be seen a cable connection that contains the first light path 6, the backscattered light path 24, and the cable 37.

FIG. 9A, 9B, 9C, and 9D are illustrative mechanical views of the internal parts of a fixed focus-camera head 2 using an f-theta lens assembly as the second focusing optic element 18, and a collection fiber bundle as backscattered light path 24.

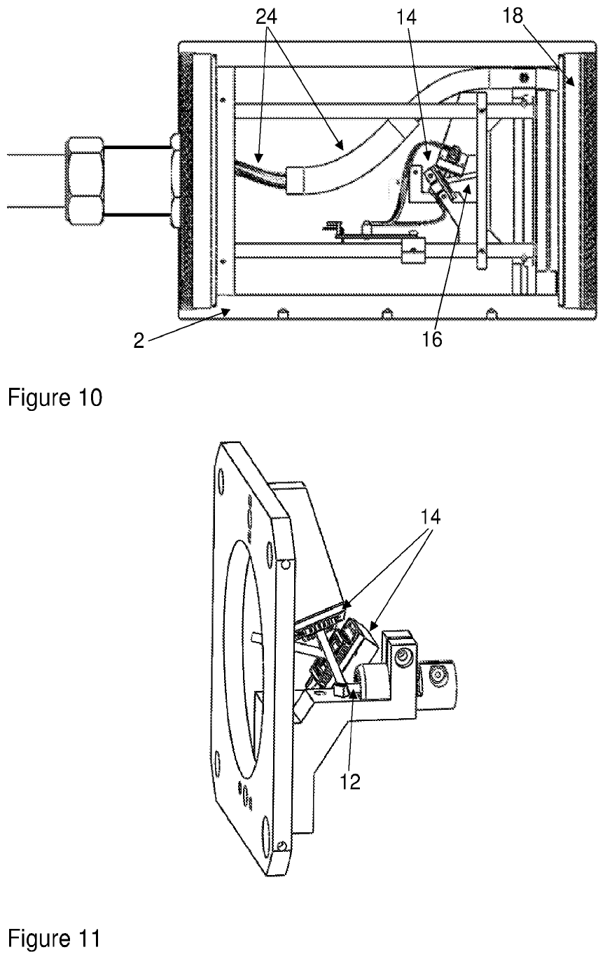

FIG. 10 is a mechanical cross-section view of the internal parts of a fixed-focus camera head 2 using an f-theta lens assembly as the second focusing optic element 18, and a collection fiber bundle as scattered light path 24. Also illustrated is a MEMS-based scanning mirror system 14 and focused oriented light 16 prior to entering the second focusing optical element 18.

FIG. 11 is a mechanical isolation view of the scanning mirror system 14 using a collimated optical fiber as first light path 6 for delivered light 8 (not explicitly shown) that becomes focused light 12 that is passed through the dual MEMS scanning mirror system 14.

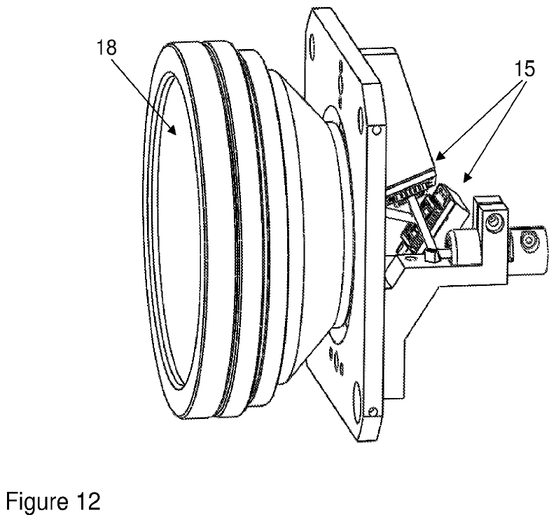

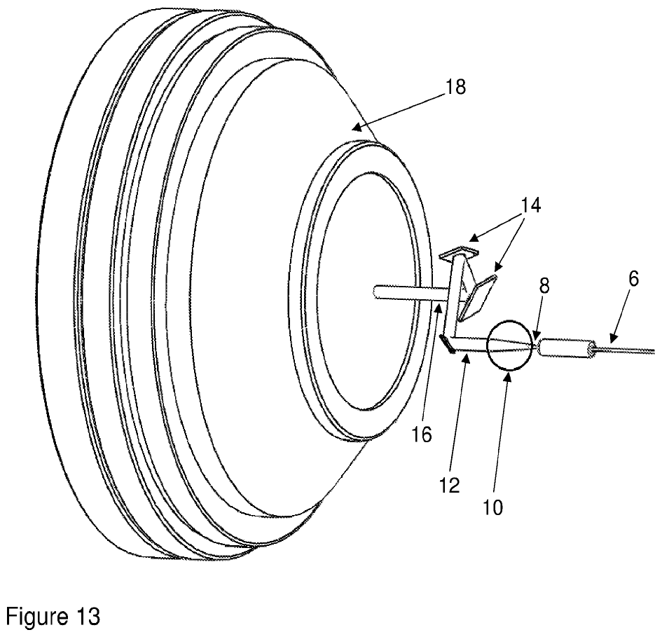

FIG. 12 is a mechanical isolation view of the scanning mirror system 14 using a collimated optical fiber as first light path 6 for delivered light 8 that becomes focused light 12 that is passed through the dual MEMS scanning mirror system 14, including the f-theta output lens as second focusing optic element 18.

FIG. 13 provides an alternate mechanical isolation view of the scanning mirror system 14 using a collimated optical fiber as first light path 6 for delivered light 8 that becomes focused light 12 that is passed through the dual MEMS scanning mirror system 14, including the f-theta output lens as second focusing optic element 18.

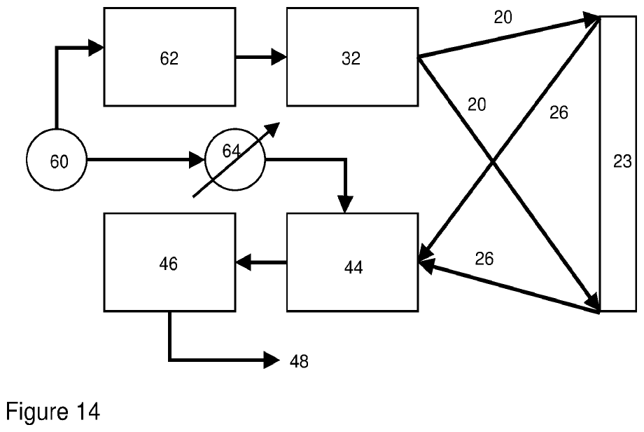

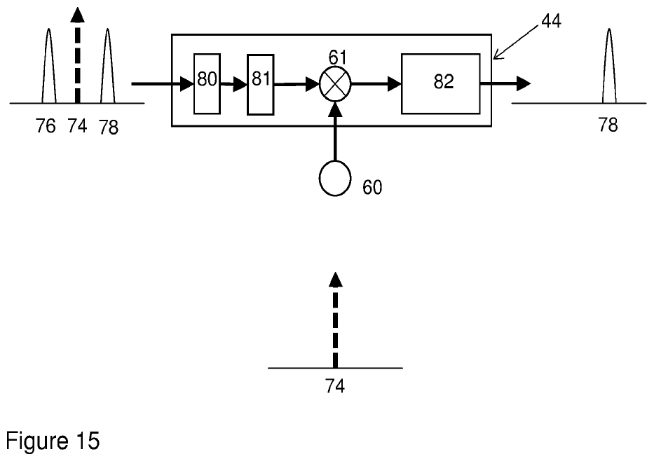

In some, but not all, embodiments, homodyning can be applied to scanning light source (active light source 32) to project the light 22 onto a scene (e.g., object 23) and then to the collected, backscattered light 26 into a homodyne detection circuit for image processing. For example, consider FIG. 14, which is a diagram of an embodiment of a homodyne transceiver locatable in control electronics 30, such that depending on the configuration of interest, has components within those shown in FIGS. 1 and 2. For example, image processing electronics 46 can include oscillator 60 configured to control an active light source driver 62, that can if desired be included in the active light source 32 so as to drive the active light source 32. The delivered light 8 from the active light source 32 is delivered to the camera head 2 and scanned via a scanning mirror system, e.g., 14, etc. The scanned light (focused, oriented light 20 and 20′ at times tn and tm) is scattered from the image scene, such as from object 23, as backscattered light 26 and 26′. The backscattered light (26 and 26′) is collected and guided to the active light detector 44 in the control electronics 30. Optionally, if so desired, a phase controller 64, located e.g., in the active light source 32 so as to adjust the phase of the oscillator 60 signal as in a homodyne receiver. The detected signal at the active light detector 44, as shown in the FIG. 15, is mixed (optical and/or electrical mixing techniques) in the active light detector 44 to produce a recovered signal that is then processed by image processing electronics 46 (and/or software) to reconstruct the image of the object 23 and delivered to display electronics 48 (not shown).

More particularly, the carrier driver 62 can use a light source driver circuit and add the capability of varying the intensity of the delivered light 8 about an average intensity using the signal from the oscillator 60 in operable connection with the active light source 32 to produce modulated light 20 and 20′, which is then distributed onto a scene such as object 23. Referring to FIG. 14, the light 20 and 20′ is scanned horizontally during each vertical step (t1, t2, etc.) until the scene or object 23 has been illuminated. Homodyne detection in control electronics 30 and active light detector 44 handles the backscattered 26 by the image scene, such as object 23 so as to be further modulated (in addition to the oscillator 60 carrier frequency) by the intensity variation (i.e., an image modulation signal) of the backscattered light 26 and is collected into a detection circuit of the active light detector 44. As may be desired in one implementation or another, a phase shift controller 64 may be used for adjustment of the oscillator 60, e.g., a local oscillator, to improve detection of the backscattered modulation signal (image modulation signal).

The active light source 32 and the active detector 44 can be combined with further elements to form a homodyne transceiver. For example, a modulation and demodulation circuit is represented in FIG. 14 by using the same oscillator's 60 frequency that modulates the light source 32, with a (optional phase shift controller 64) controller to phase lock to the transmitted carrier frequency and the received signal from the active light detector 44, as illustrated in FIG. 14.

FIG. 15 provides a diagram of a homodyne demodulator. A frequency spectrum 74 of the local oscillator, including 76, 74, 78 as the frequency spectrum of the modulated input to the active light detector 44 containing the oscillator signal 74 and the mixed frequency components of the backscattered image signals (76 and 78) from backscattered light 26 and 26′ in FIG. 14. The active light detector 44 of FIG. 14 is indicated as the box in FIG. 15. Active detector element 80 is an active light detector 44 that includes transimpedance amplifier. A band pass filter 81 is configured to select the frequency spectrum of the signals of interest (74, 76, and 78), and mixer 61 cooperates with a low pass filter 82 to select the recovered demodulated signal 78. The local oscillator 60 generates the frequency 74. Note: the phase shifter 64 is not used in this configuration.

### Statement of Scope

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. An apparatus comprising:
a camera head that is high radiation tolerant and control electronics that is less high radiation tolerant, the camera head devoid of an active light source and devoid of an active light detector, the camera head comprising:
a first end of a first light path located to emit delivered light, the first light path comprising one or more radiation-tolerant optical fibers;
a first focusing optic element located to focus the delivered light as focused light;
a scanning mirror system located to orient the focused light as oriented light;
a second focusing optic element located to focus the oriented light as focused oriented light; and
a first end of a backscattered light path located to collect backscattered light from the focused oriented light as collected light, the backscattered light path comprising one or more radiation-tolerant optical fibers; and
the control electronics comprising:
a laser light source connected so as to deliver the delivered light to a second end of the first light path;
a control that governs the scanning mirror system;
a second end of the backscattered light path located to emit the collected light as received light;
an active light detector located to detect the received light as detected light;
electronics, or electronics and software, that constructs an image from the detected light; and
display electronics that displays the image.

2-6. (canceled)

7. The apparatus of claim 1, further including a filter intermediate the second end of the backscattered light path and the active light detector.

8-18. (canceled)

19. The apparatus of claim 1, wherein the first focusing optic element is a collimating optic element.

20. The apparatus of claim 1, wherein the second focusing optical element is comprised of a lens.

21. The apparatus of claim 1, wherein the second focusing optical element is comprised of an F-theta lens.

22-24. (canceled)

25. The apparatus of claim 1, wherein the scanning mirror system is comprised of a single, 2-axis MEMS or two single-axis MEMS.

26-27. (canceled)

28. The apparatus of claim 1, further including a third optic element, adjacent the first end of the backscattered light path, positioned to direct the backscattered light toward the backscattered light path.

29. The apparatus of claim 1, wherein the active light source and the active light detector comprise a homodyne transceiver.

30. A process of using the apparatus of claim 1, the process comprising:
locating a camera head in a higher radiation environment than control electronics,
the process further comprising:
emitting delivered light from the first end of the first light path;
focusing the delivered light with the first focusing optic element to produce focused light;
orienting the focused light with the scanning mirror system to produce oriented light;
focusing the oriented light with the second focusing optic element to produce focused oriented light; and
collecting backscattered light from the focused oriented light using the first end of the backscattered light path; and
the process further comprising:
delivering, from a laser, the delivered light to the second end of the first light path;
emitting, from the second end of the backscattered light path the collected light as received light;
detecting, with the active light detector the received light as detected light;
constructing, with the control electronics, or the control electronics and software, an image from the detected light; and
displaying the image; and
operating the camera head and the control electronics to produce the image derived from the higher radiation environment.

31-58. (canceled)

59. A process of producing at least some of the apparatus of claim 1, the process comprising:
assembling a high radiation tolerant camera head, control electronics, or both the camera head and the control electronics, such that the camera head is operable in a higher radiation environment than the control electronics,
the camera head devoid of an active light source and devoid of an active light detector and comprising:
a first end of a first light path located to emit delivered light, the first light path comprising one or more radiation-tolerant optical fibers;
a first focusing optic element located to focus the delivered light as focused light;
a scanning mirror system located to orient the focused light as oriented light;
a second focusing optic element located to focus the oriented light as focused oriented light; and
a first end of a backscattered light path located to collect backscattered light from the focused oriented light as collected light, the backscattered light path comprising one or more radiation-tolerant optical fibers; and
the control electronics having connections to render the camera head operable to produce an image, and further comprising:
a laser connected so as to deliver the delivered light to a second end of the first light path; a control that governs the scanning mirror system; a second end of the backscattered light path located to emit the collected light as received light;
an active light detector located to detect the received light as detected light;
electronics, or the electronics and software, that constructs the image from the detected light; and
display electronics that displays the image.

60-88. (canceled)

89. A camera head that renders the apparatus of claim 1 operable to produce imagery.

90. Control electronics that renders the apparatus of claim 1 operable to produce imagery.

91. The apparatus of claim 28, wherein the active light source and the active light detector comprise a homodyne transceiver.

92. The apparatus of claim 1, wherein the camera head is is operable in high levels of radiation, above background radiation levels, as encountered in a nuclear reactor.

93. The apparatus of claim 1, wherein the camera head is is operable in high levels of radiation, above background radiation levels, as encountered in any of:
nuclear power plant refueling, inspection, and monitoring;
nuclear fuel production, inspection, and storage; or
nuclear spent fuel inspection, repair, and storage.

94. The process of claim 30, wherein the locating the camera head in the higher radiation environment includes locating the camera head in a nuclear reactor.

95. The process of claim 30, wherein the locating the camera head in the higher radiation environment includes locating the camera head in a radiation environment of any of nuclear power plant refueling, inspection, and monitoring.

96. The process of claim 30, wherein the locating the camera head in the higher radiation environment includes locating the camera head in a radiation environment of any of nuclear fuel production, inspection, and storage.

97. The process of claim 30, wherein the locating the camera head in the higher radiation environment includes locating the camera head in a radiation environment of any of nuclear spent fuel inspection, repair, and storage.

98. The process of claim 30, wherein the delivering, from the laser, the delivered light, and the detecting, with the active light source, are carried out within the control electronics or the control electronics and software in forming a homodyne transceiver.
